(19) United States
(12) Patent Application Publication
(10) Pub. No.: US 2006/0114397 A1
(43) Pub. Date: Jun. 1, 2006

(54) Vertical-alignment liquid crystal display device

(75) Inventors: Ryota Mizusako, Sagamihara-shi (JP); Minoru Yamaguchi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/288,521

(22) Filed: Nov. 29, 2005

(30) Foreign Application Priority Data
Nov. 30, 2004 (JP) 2004-347732
Mar. 28, 2005 (JP) 2005-91143

(51) Int. Cl. G02F 1/1343; G02F 1/1337

(52) U.S. Cl. 349/139; 349/130

(57) ABSTRACT

A vertical-alignment liquid crystal display device includes: one substrate on which plural pixel electrodes and thin film transistors (TFTs) corresponding to the pixels, scanning signal lines for supplying gate electrodes of these TFTs with a gate signal, and data signals lines for supplying drain electrodes of the TFTs with data signals are provided; an opposing substrate on which an opposing electrode opposed to the pixel electrodes is provided; vertical-alignment films covering surfaces of the respective substrates where electrodes are formed; and a liquid crystal layer sealed between these substrates and having a negative dielectric constant. On the inner surface of the one substrate, auxiliary electrodes to generate electric fields of a predetermined value between the auxiliary electrodes and the opposing electrode provided on the inner surface of the other substrate are provided respectively corresponding to those portions around the plural pixel electrodes that are close to at least the TFTs.

### BACKGROUND OF THE INVENTION

1. Field of the Invention

The present invention relates to a vertical alignment active matrix liquid crystal display device in which thin film transistors (hereinafter referred to as TFTs) are active elements.

2. Description of the Related Art

A vertical-alignment liquid crystal display device has: a pair of substrates which are opposed to each other with a predetermined gap maintained between each other, plural electrodes which are provided on each of opposed inner surfaces of the paired substrates, to form plural pixels arrayed in a matrix on regions opposed to each other; vertical-alignment films provided respectively on the inner surfaces of the paired substrates covering the electrodes; and a liquid crystal layer which is sealed in the gap between the paired substrates and has negative dielectric anisotropy.

In this vertical-alignment liquid crystal display device, the alignment state of liquid crystal is changed from a vertical-alignment state to a tilted-alignment state in which liquid crystal molecules are tilted, by applying a voltage between the electrodes, for every one of the plural pixels consisting of regions where plural pixel electrodes and an opposing electrode are opposed to each other.

For example, as described in the specification of Japanese Patent Publication No. 2565639, the vertical-alignment active matrix liquid crystal display device includes: a pair of opposing substrates; plural pixel electrodes which are provided on the inner surface of one substrate among inner surfaces of the paired substrates, opposed to each other, and which are arrayed in a matrix in row and column directions; plural TFTs which are provided on the inner surface of the one substrate, respectively near and corresponding to the plural pixel electrodes, and which are connected respectively to the corresponding pixel electrodes; plural gate signal lines and data signal lines which are provided on the inner surface of the one substrate, respectively between rows of the pixel electrodes and between columns of the pixel electrodes, and which supply a gate signal and a data signal to the TFTs on the corresponding rows and columns; an opposing electrode provided on the inner surface of the other substrate and opposed to the plural pixel electrodes; vertical-alignment films respectively provided on the inner surfaces of the pair of substrates, covering the electrodes; and a liquid crystal layer sealed in a gap between the pair of substrates and having negative dielectric anisotropy.

Even in this vertical-alignment active matrix liquid crystal display device, liquid crystal molecules are oriented so as to tilt from a vertical-alignment state by applying a voltage between the electrodes, for every one of plural pixels constituted by regions where plural pixel electrodes and an opposing electrode are opposed to each other. An image is thus displayed.

However, conventional vertical-alignment active matrix liquid crystal display devices have a problem that the tilted-alignment state of liquid crystal molecules is disturbed by the voltage applied to electrodes of each pixel, and so, display states of respective pixels are not uniform.

### SUMMARY OF THE INVENTION

An object of the present invention is to provide a vertical-alignment active matrix liquid crystal display device capable of displaying an image of excellent quality without roughness by reducing disturbance in alignment between pixels.

To achieve the above object, a liquid crystal display device according to the first aspect of the present invention comprises: a pair of substrates opposed to each other with a predetermined gap maintained therebetween; plural pixel electrodes provided on an inner surface of one of the substrates among mutually-opposing inner surfaces of the substrates, and aligned in a matrix in row and column directions; plural thin film transistors provided respectively corresponding to the plural pixel electrodes, on the inner surface of the one of the substrates, and respectively connected to corresponding pixel electrodes; scanning signal lines and data signal lines provided respectively between pixel electrode rows and between pixel electrode lines, in which the plural pixel electrodes are arrayed in row and column directions, on the inner surface of the one of the substrates, thereby to connect plural thin film transistors to each other in each of the pixel electrode rows and in each of the pixel electrode columns, and to supply a scanning signal and a data signal to each of the thin film transistors; an opposing electrode provided on an inner surface of the other one of the substrates and opposed to the plural pixel electrodes; auxiliary electrodes provided on the inner surface of the one of the substrates, respectively corresponding to those portions of the plural pixel electrodes that are close at least to the thin film transistors, and respectively between the pixel electrodes and the thin film transistors, the auxiliary electrodes being applied with a predetermined potential; vertical-alignment films respectively provided on the inner surfaces of the pair of substrates, covering the electrodes; and a liquid crystal layer sealed in the gap between the pair of substrates and having negative dielectric anisotropy.

In the liquid crystal display device according to the first aspect, the auxiliary electrodes to generate electric fields of a predetermined value between these auxiliary electrodes and the opposing electrode on the other one of the substrates are provided on the inner surface of the one of the substrates, respectively corresponding to those portions in the peripheries of plural pixel electrodes that are adjacent at least to thin film transistors. Therefore, even when a large potential difference exists between the thin film transistors supplied with a scanning signal and the pixel electrodes, an electric field caused by the potential difference is shielded by the auxiliary electrodes, i.e., the auxiliary electrodes function as shield electrodes. As a result, it is possible to reduce disturbance in alignment of liquid crystal molecules in each pixel, which is caused by disturbance in electric fields in peripheral portions of pixels due to the large potential difference between the thin film transistors and the pixel electrodes. Accordingly, an image of excellent quality without roughness can be displayed.

Preferably in the liquid crystal display device according to the present invention, each of the auxiliary electrodes is arranged, partially opposed to the opposing electrode, and an electric field of a predetermined value is generated between each of the auxiliary electrodes and the opposing electrode. Desirably in this case, the auxiliary electrodes are set to a potential equal to that of the opposing electrode, to form a region applied with no electric field between the auxiliary electrodes and the opposing electrode.

Further preferably, the auxiliary electrodes are provided respectively corresponding to peripheral portions adjacent at least to the thin film transistors and the scanning signal lines, around the pixel electrodes. Desirably, the auxiliary electrodes each are provided throughout the whole periphery of the pixel electrode. Also preferably, the auxiliary electrodes each are formed, partially overlapping the pixel electrode along peripheral portions of the pixel electrode, with an insulating film inserted therebetween. Further desirably, the auxiliary electrodes are formed to be integral with capacitor electrodes forming compensating capacitor between the auxiliary electrodes and the pixel electrodes.

In the liquid crystal display device according to the present invention, there is a case that the auxiliary electrodes further have auxiliary electrode connection portions formed at mutually-opposing peripheries of each adjacent ones of the pixel electrodes in each of the pixel electrode rows. Desirably in this case, each adjacent ones of the auxiliary electrodes in each of the pixel electrode rows are connected to each other at plural portions by the auxiliary electrode connection portions. Further preferably, adjacent ones of the auxiliary electrodes in each of the pixel electrode rows are formed in an integral shape, to be connected to each other.

Also preferably in the liquid crystal display device according to the present invention, the auxiliary electrodes are formed on a substrate surface of the one of the substrates, the pixel electrodes are formed on an insulating film provided covering the auxiliary electrodes, and connection electrodes connecting the pixel electrodes to electrodes on semiconductor films of the thin film transistors are formed such that portions thereof extending above the auxiliary electrodes are shaped to be narrower than a width of the electrodes on the semiconductor films of the thin film transistors. Further in this case, the pixel electrodes each are formed in a shape in which such a part of a periphery of the pixel electrode that is adjacent to the thin film transistor is apart from the thin film transistor, a connection electrode connecting an electrode of the thin film transistor on a semiconductor film to the pixel electrode is formed to intersect the pixel electrode, within a region corresponding to the part apart from the thin film transistor.

A liquid crystal display device according to the second aspect of the present invention comprises: a pair of substrates opposed to each other with a predetermined gap maintained therebetween; plural pixel electrodes provided on an inner surface of one of the substrates among mutually-opposing inner surfaces of the substrates, and aligned in a matrix in row and column directions; plural thin film transistors provided respectively corresponding to the plural pixel electrodes, on the inner surface of the one of the substrates, and respectively connected to corresponding pixel electrodes; scanning signal lines and data signal lines provided respectively between pixel electrode rows and between pixel electrode columns, in which the plural pixel electrodes are arrayed in row and column directions, on the inner surface of the one of the substrates, thereby to connect plural thin film transistors to each other in each of the pixel electrode rows and in each of the pixel electrode columns, and to supply a scanning signal to a gate electrode of each of the thin film transistors as well as a data signal to a drain electrode of each of the thin film transistors; an opposing electrode provided on an inner surface of the other one of the substrates and opposed to the plural pixel electrodes; auxiliary electrodes provided on the inner surface of the one of the substrates, at least between the plural pixel electrodes and the thin film transistors respectively corresponding to pixels, thereby to shield an electric field applied between the gate electrodes and the pixel electrodes; vertical-alignment films provided respectively on the inner surfaces of the pair of substrates, covering the electrodes; and a liquid crystal layer sealed in the gap between the pair of substrates and having negative dielectric anisotropy.

The liquid crystal display device according to the second aspect comprises the auxiliary electrodes, which are respectively formed at least between the plural pixel electrodes and the thin film transistors corresponding to the pixels, to shield electric fields applied between the gate electrodes of the thin film transistors and the pixel electrodes. Therefore, even when a large potential difference exists between the thin film transistors supplied with a scanning signal and the pixel electrodes, an electric field generated by the potential difference is shielded by the auxiliary electrodes, i.e., the auxiliary electrodes function as shield electrodes. As a result, it is possible to reduce disturbance in alignment of liquid crystal molecules in each pixel, which is caused by disturbance in electric fields in peripheral portions of pixels due to the large potential difference between the thin film transistors and the pixel electrodes. Accordingly, an image of excellent quality without roughness can be displayed.

Preferably in the liquid crystal display device according to the present invention, the auxiliary electrodes each are provided between the pixel electrode, the gate electrode of the thin film transistor, and a scanning line which supplies the gate electrode with a scanning signal. Also desirably, the auxiliary electrodes each are formed along peripheral portions of the pixel electrode, with a part of the auxiliary electrode overlapping the pixel electrode through an insulating film, and with another part thereof opposed to the opposing electrode. Further desirably, the auxiliary electrodes each are provided throughout the whole periphery of the pixel electrode.

Also preferably, the auxiliary electrodes are formed to be integral with capacitor electrodes forming compensating capacitor between the auxiliary electrodes and the pixel electrodes. Further desirably, the auxiliary electrodes each are formed to be opposed to the opposing electrode along peripheral portions of the pixel electrode, and are set to a potential substantially equal to a potential of the opposing electrode, thereby to form a region applied with no electric field between the auxiliary electrode and the opposing electrode. Further preferably, each of the plural pixel electrodes is provided with a slit which divides the plural pixel electrode into plural electrode portions, and an extension portion corresponding to the slit is formed on each of the auxiliary electrodes.

A liquid crystal display device according to the third aspect of the present invention comprises: a pair of substrates opposed to each other with a predetermined gap maintained therebetween; plural pixel electrodes provided on one of the substrates, among mutually-opposing inner surfaces of the pair of substrates, and arrayed in a matrix in row and column directions; plural thin film transistors formed on the inner surface of the one of the substrates, respectively corresponding to the plural pixel electrodes and connected to corresponding ones of the pixel electrodes; scanning signal lines and data signal lines provided respectively between pixel electrode rows and between pixel electrode columns, in which the plural pixel electrodes are arrayed in row and column directions, on the inner surface of the one of the substrates, thereby to connect plural thin film transistors to each other in each of the pixel electrode rows and in each of the pixel electrode columns, and to supply a scanning signal and a data signal to each of the thin film transistors; an opposing electrode provided on an inner surface of the other one of the substrates and opposed to the plural pixel electrodes; plural auxiliary electrodes provided on the inner surface of the one of the substrates, respectively surrounding the whole peripheries of the plural pixel electrodes, opposed to peripheral portions of the pixel electrodes at inner peripheral portions of the auxiliary electrodes, thereby to form a compensating capacitor between the auxiliary electrodes and the pixel electrodes, and also opposed to the opposing electrode at those portions of the auxiliary electrodes that extend to around the pixel electrodes, respectively, thereby to generate electric fields of a predetermined value between the auxiliary electrodes and the opposing electrode; plural auxiliary electrode connection portions formed respectively between the plural auxiliary electrodes, thereby to connect every adjacent ones of the auxiliary electrodes on each of the rows, to each other, at plural portions of adjacent edge portions of the every adjacent ones of the auxiliary electrodes; vertical-alignment films provided respectively on the inner surfaces of the pair of substrates, covering the electrodes; and a liquid crystal layer sealed in the gap between the pair of substrates and having negative dielectric anisotropy.

In the liquid crystal display device according to the third aspect, plural auxiliary electrode connection portions are formed between every adjacent ones of the plural auxiliary electrodes in each row. By the plural auxiliary electrode connection portions, every adjacent ones of the auxiliary electrodes in each row are connected to each other at two portions on one end side and another end side of adjacent edge portions of these auxiliary electrodes. Therefore, the auxiliary electrodes can be connected with a sufficiently small resistance value, so that a sufficient aperture ratio can be obtained steadily.

Preferably in the liquid crystal display device according to the present invention, the auxiliary electrodes are formed on a substrate surface of the one of the substrate, the pixel electrodes are formed on an insulating film provided covering the auxiliary electrodes, and connection electrodes connecting the pixel electrodes to electrodes on semiconductor films of the thin film transistors are formed such that portions thereof extending above the auxiliary electrodes are shaped to be narrower than a width of the electrodes on the semiconductor films of the thin film transistors.

### BRIEF DESCRIPTION OF THE DRAWINGS

These objects and other objects and advantages of the present invention will become more apparent upon reading of the following detailed description and the accompanying drawings in which:

FIG. 1 is a plan view showing one pixel part in one of substrates in a liquid crystal display device according to the first embodiment of the present invention;

FIG. 2 is a cross-sectional view cut along the line II-II in FIG. 1;

FIG. 3 is a cross-sectional view cut along the line III-III in FIG. 1;

FIG. 4 is a cross-sectional view schematically showing a tilted-alignment state of liquid crystal molecules in one pixel part in the first embodiment;

FIG. 5 is a plan view schematically showing a tilted-alignment state of liquid crystal molecules in one pixel part in the first embodiment;

FIG. 6 is a plan view showing one pixel part in one of substrates in a liquid crystal display device according to the second embodiment of the present invention;

FIG. 7 is a plan view showing one pixel part in one of substrates in a liquid crystal display device according to the third embodiment of the present invention;

FIG. 8 is a plan view showing one pixel part in one of substrates in a liquid crystal display device according to the fourth embodiment of the present invention;

FIG. 9 is a cross-sectional view showing the liquid crystal display device cut along the line IX-IX in FIG. 8;

FIG. 10 is a cross-sectional view schematically showing a tilted-alignment state of liquid crystal molecules in one pixel part in the fourth embodiment;

FIG. 11 is a plan view schematically showing a tilted-alignment state of liquid crystal molecules in one pixel part in the fourth embodiment;

FIG. 12 is a plan view showing one pixel part in one of substrates in a liquid crystal display device according to the fifth embodiment of the present invention;

FIG. 13 is a cross-sectional view showing the liquid crystal display device cut along the line XIII-XIII in FIG. 12;

FIG. 14 is a cross-sectional view schematically showing a tilted-alignment state of liquid crystal molecules in one pixel part in the fifth embodiment; and

FIG. 15 is a plan view schematically showing a tilted-alignment state of liquid crystal molecules in one pixel part in the fifth embodiment

### DETAILED DESCRIPTION OF THE PREFERRED EMBODIMENTS

Liquid crystal display devices will be described below as embodiments of the present invention with reference to the accompanying drawings.

### First Embodiment

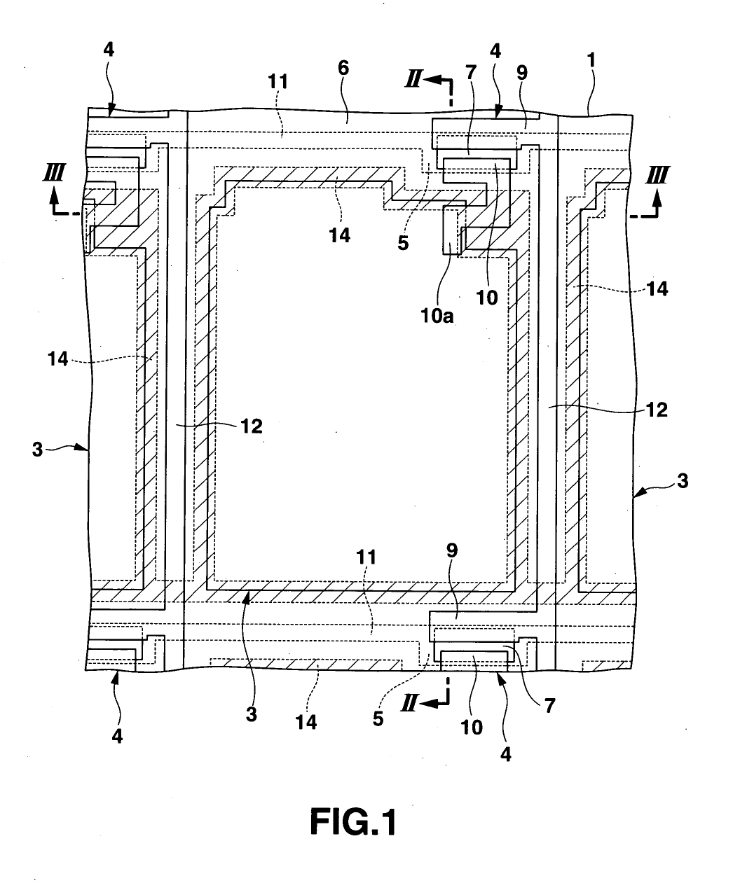

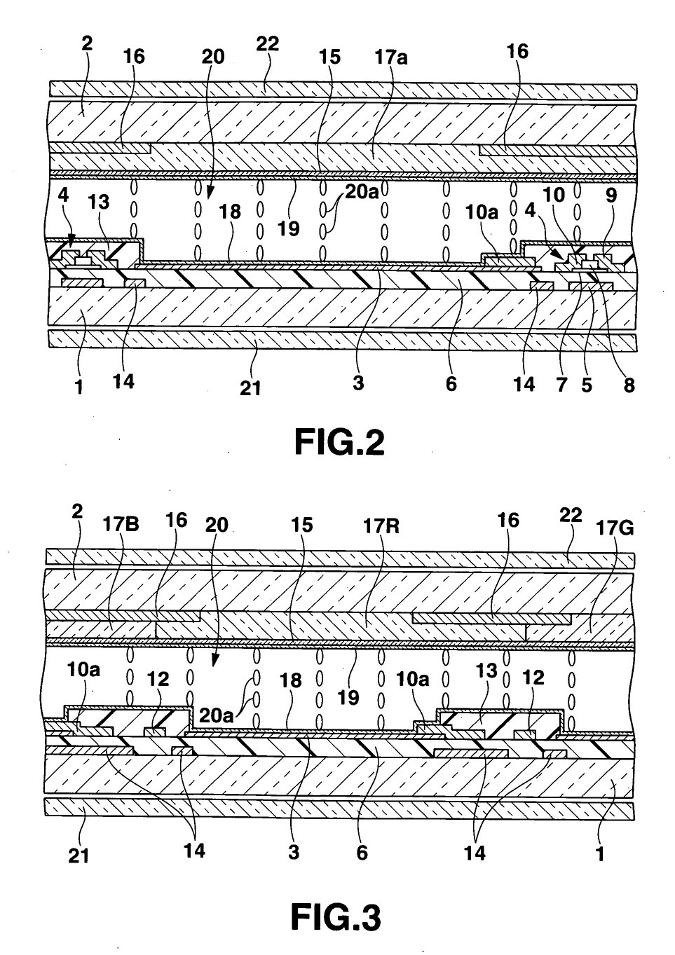

FIGS. 1 to 5 shows the first embodiment of the present invention. FIG. 1 is a plan view of one pixel part in one substrate of a liquid crystal display device. FIGS. 2 and 3 are cross-sectional views showing the liquid crystal display device, cut along the lines II-II and III-III in FIG. 1.

This liquid crystal display device is a vertical-alignment active matrix liquid crystal display device in which TFTs are active elements. As shown in FIGS. 1 to 3, the liquid crystal display device has a pair of transparent substrates 1 and 2 opposed to each other with a predetermined gap maintained therebetween; plural transparent electrodes 3 which are provided on the inner surface of the substrate 1, of mutually-opposing inner surfaces of the paired substrates 1 and 2, and are arrayed in a matrix along row and column directions; plural TFTs 4 provided on the inner surface of the substrate 1, respectively near and corresponding to the plural pixel electrodes 3, and connected respectively to the corresponding pixel electrodes 3; plural gate signal lines (scanning signal lines) 11 and data signal lines 12 provided on the inner surface of the substrate 1, the plural gate signal lines being respectively provided along one sides of pixel electrode rows, and the plural data signal lines 12 being respectively provided along one sides of pixel electrode columns, to supply gate signals (scanning signals) and data signals to the TFTs 4 on the corresponding rows and columns; a transparent opposing electrode 15 of single-film type provided on the inner surface of the other substrate 2, and opposed to the plural pixel electrodes 3; vertical-alignment films 18 and 19 respectively provided on the inner surfaces of the pair of substrates 1 and 2, covering the electrodes 3 and 15; and a nematic liquid crystal layer 20 sealed in the gap between the paired substrates 1 and 2 and having negative dielectric anisotropy.

Hereinafter, the one substrate on which the pixel electrodes 3, TFTs4, gate signal lines 11, and data signal lines 12 are provided will be called a TFT substrate. The other substrate 2 on which the opposing electrode 15 is provided will be called an opposing electrode.

Meanwhile, this liquid crystal display device is a color image display device. A lattice-film-like black mask 16, and three color filters 17R, 17G, and 17B of red, green, and blue are provided on the inner surface of the opposing substrate 2. The black mask 16 is opposed to regions between plural pixels consisting of regions where the plural pixel electrodes 3 and the opposing electrode 15 are opposed to each other. Each of the color filters 17R, 17G, and 17B corresponds to one pixel column. The opposing electrode 15 is formed on the color filters 17R, 17G, and 17B. One of the vertical-alignment films 19 is formed on the opposing electrode 15.

The plural TFTs 4 are constituted by: gate electrodes 5 formed on the substrate surface of the TFT substrate 1; a transparent gate insulating film 6 formed over the entire of the arrayed region of the pixel electrodes 3, covering the gate electrodes 5; an i-type semiconductor film 7 formed on the gate insulating film 6 and opposed to the gate electrodes 5; a blocking insulating film 8 formed covering channel regions of the i-type semiconductor film 7; and drain electrodes 9 and source electrodes 10 formed, with an n-type semiconductor film (not shown) inserted thereunder on side portions and the other side portions of the channel regions of the i-type semiconductor film 7, with the channel regions respectively inserted between the drain electrodes 9 and source electrodes 10.

The gate signal lines 11 are formed on the substrate surface of the TFT substrate 1, to be integral with the gate electrodes 5 of the TFTs 4. The data signal lines 12 are formed on the gate insulating film 6, to be integral with the drain electrodes 9 of the TFT 4.

The pixel electrodes 3 are formed on the gate insulating film 6. The source electrodes 10 of the TFTs 4 are extended to above the gate insulating film 6 and connected to the pixel electrodes 3.

Further, the TFTs 4 and the data signal lines 12 are covered with an overcoat insulating film 13 formed on the inner surface of the TFT substrate 1 except portions corresponding to the respective pixel electrodes 3. The vertical-alignment film 18 is formed on the overcoat insulating film 13.

Further, the liquid crystal display device has auxiliary electrodes 14 provided on the inner surface of the TFT substrate 1, respectively corresponding to at least portions adjacent to the TFTs 4, around the plural pixel electrodes. The auxiliary electrodes 14 are opposed to the opposing electrode 15 on the inner surface of the opposing substrate 2. The auxiliary electrodes 14 generate an electric field of a predetermined value lower than the voltage value of gate signals supplied to the gate electrodes 5 of the TFTs 4, between the auxiliary electrodes 14 and the opposing electrode 15, through the gate signal lines 11.

It is preferred that the auxiliary electrodes 14 are provided corresponding to at least those peripheral portions of the pixel electrodes 3 that are adjacent to the gate electrodes and gate signal lines 11 of the TFTs 4. More preferably, the auxiliary electrodes 14 are provided throughout the whole peripheries of the pixel electrodes 3.

In this embodiment, the auxiliary electrodes 14 are provided throughout the whole peripheries of the pixel electrodes 3. In FIG. 1, portions corresponding to the auxiliary electrodes 14 are hatched with parallel oblique lines to help easy understanding of this figure.

The auxiliary electrodes 14 are formed to be integral with capacitor electrodes which form a compensating capacitor between the auxiliary electrodes 14 and the pixel electrodes 3. Thus, the auxiliary electrodes 14 also serve as the capacitor electrodes.

That is, the auxiliary electrodes 14 each are formed of a flame-like metal film, transparent conductive film, or conductive film of a composite film consisting of a metal film and a transparent conductive film. The film is provided corresponding to the whole periphery of the pixel electrode 3, on the substrate surface of the TFT substrate 1. In this case, the transparent conductive films are respectively formed at portions overlapping the pixel electrodes. Edge portions of this frame-like conductive film are formed to be such wide that the inner peripheral portions thereof are opposed to peripheral portions of the pixel electrode 3 through the gate insulating film 6 and the outer peripheral portions extend to the outside of the pixel electrode 3.

Further, the inner peripheral portions of the edge portions of the flame-like conductive film form a capacitor electrode portion between the inner peripheral portions and the peripheral portions of the pixel electrode 3. The capacitor electrode portion forms a compensating capacitor, with the gate insulating film 6 used as a dielectric film. The outer peripheral portions of the edge portions, i.e., the portions extended out of the pixel electrode 3 form an auxiliary electrode portion which is opposed to the opposing electrode 15 and generates an electric field of the predetermined value described previously, between the outer peripheral portions and the opposing electrode 15.

Note that the auxiliary electrodes 14 are formed on the substrate surface of the TFT substrate 1. The pixel electrodes 3 are formed on the gate insulating film 6 provided covering the auxiliary electrodes 14. Pixel electrode connection electrodes of the TFTs 4, i.e., the source electrodes 10 are respectively extended from above the i-type semiconductor films 7 to above the gate insulating film 6, and are connected to the pixel electrodes 3. In the regions other than the portions where the source electrodes 10 of the TFTs 4 extend, the auxiliary electrodes 14 are opposed to the opposing electrode 15.

Further, each of the source electrodes 10 has a portion which intersects the auxiliary electrode 14, extending over the auxiliary electrode 14. The intersecting portion is formed to be narrower than the width of another portion above the i-type semiconductor film 7, i.e., the channel width of the TFT 4 as far as the resistance value of the intersecting portion does not exceed an allowable value. Thus, the width of the portion where the source electrode 10 intersects the auxiliary electrode 14 is narrowed, so that the opposed region where the auxiliary electrode 14 is opposed to the opposing electrode 15 is elongated.

Further, the pixel electrode 3 is formed in a shape in which such a portion of the edges of the pixel electrode 3 that is adjacent to the TFT 4 is cut away to be apart from the TFT 4. The source electrode 10 of the TFT 4 is formed so as to extend over the auxiliary electrode 14, within the region corresponding to the portion of the pixel electrode 3 which is apart from the TFT 4.

In this embodiment, as shown in FIG. 1, among the peripheries of portions of the pixel electrode 3 adjacent to the TFTs 4, the periphery of a portion at a corner of the pixel electrode 3 is made apart from the TFTs 4. However, another portion (for example, a center portion) of the peripheries of those portions of the pixel electrode 3 that are adjacent to the TFTs 4 may be cut away and apart from the TFTs 4.

In each row of pixel electrodes, the auxiliary electrodes 14 respectively corresponding to the peripheries of the plural pixel electrodes 3 are connected integrally, at the opposite end portions of the auxiliary electrodes 14 to the side of the gate signal lines 11. Though not shown in the figures, the auxiliary electrodes 14 in each row are connected, in common, to an auxiliary electrode connection line provided in parallel with the data signal lines 11, on one end or on each of two ends outside the arrayed region of the plural pixel electrodes 3.

The pair of substrates 1 and 2 are joined to each other by a frame-like seal material not shown but surrounding the arrayed region of the plural pixel electrodes 3. The liquid crystal layer 20 is sealed in the region surrounded by the seal material between the paired substrates 1 and 2.

Liquid crystal molecules 20a in the liquid crystal layer 20 are aligned to be substantially vertical to the substrate 1 and 2, by the vertical-alignment characteristic of the vertical-alignment films 18 and 19 provided respectively on the inner surfaces of the paired substrates 1 and 2.

Though not shown in the figures, the TFT substrate 1 has extension portions protruding to the outside of the opposing substrate 2, respectively at ends in the row and column directions of the TFT substrate 1. Plural gate-side driver connection terminals are formed to be arrayed on the extension portion in the row direction. Plural data-side driver connection terminals are formed to be arrayed on the other extension portion in the column direction.

Further, the plural gate signal lines 11 described previously are guided by the extension portion in the row direction, and are respectively connected to the plural gate-side driver connection terminals. The plural data signal lines 12 also described previously are guided by the extension portion in the column direction, and are respectively connected to the data-side driver connection terminals. The auxiliary electrode connection lines described previously are guided by one or both of the extension portions in the row and column directions, and are connected to those potential supply terminals that are applied with a predetermined potential among the plural driver connection terminals of the extension portions.

Further, on the inner surface of the TFT substrate 1, there is provided at least one opposing electrode connection line which is guided by one or both of the extension portions in the row and column directions from a corner portion of the substrate-joining part based on the seal material described previously and are connected to the potential supply terminals mentioned above among the driver connection terminals (which may be the terminal identical to or different from that connected to the auxiliary electrode connection line). The opposing electrode 15 provided on the inner surface of the opposing substrate 2 is connected to the opposing electrode connection line at the substrate-joining part, and is connected to the potential supply terminals through the opposing electrode connection line.

Specifically, in the present embodiment, the potential of the plural auxiliary electrodes 14 is set to a (predetermined) potential equal to or slightly different from the potential of the opposing electrode 15. An electric-field-free state (where the voltage between electrodes is 0 V) is generated between these auxiliary electrodes 14 and the opposing electrode 15.

On the outer surfaces of the paired substrates 1 and 2, respectively, polarizing plates 21 and 22 are arranged, with their transmission axes oriented in predetermined directions. In this embodiment, the polarizing plates 21 and 22 are arranged substantially at right angles to each other, to make the liquid crystal display device perform display in a normally-black mode.

In this liquid crystal display device, voltages are applied between the pixel electrodes 3 and the opposing electrode 15, thereby to orient liquid crystal molecules 20a to tilt from the vertical-alignment state. Thus, an image is displayed.

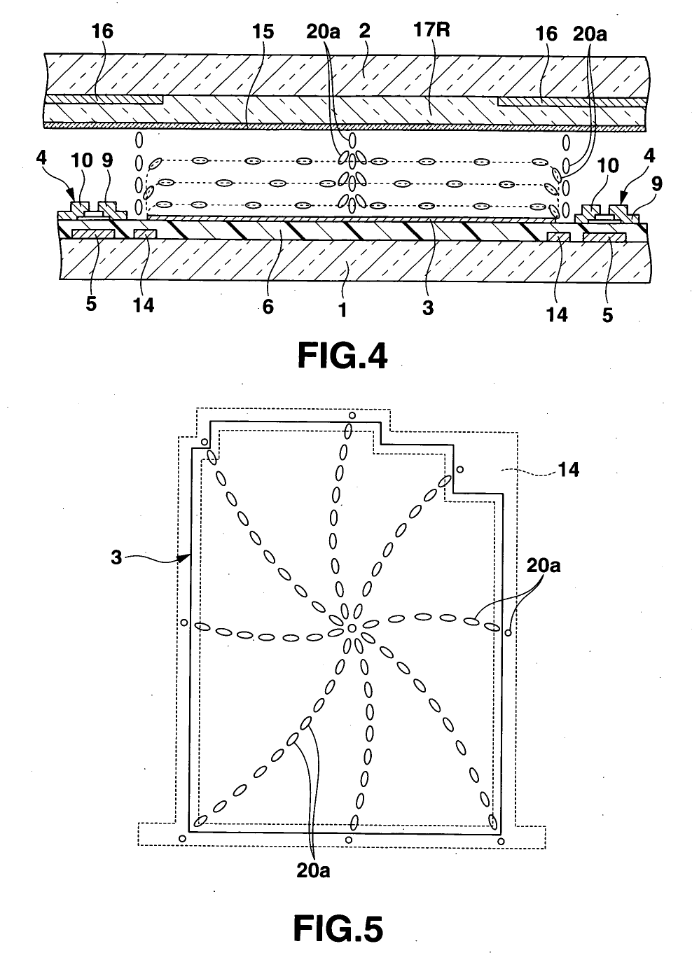

FIGS. 4 and 5 are plan and cross-sectional views showing a tilted-alignment state of liquid crystal molecules 20a in one pixel part of the liquid crystal display device. For every pixel, the liquid crystal molecules 20a are oriented to tilt toward the center portion from the peripheral portions of the pixel, aligned spirally, with the major axes of molecules oriented in directions along the equipotential lines shown as broken lines in FIG. 4, as a signal voltage described above is applied. The liquid crystal molecules in the center portion of the pixel are oriented to be aligned vertically by intermolecular force acting between these liquid crystal molecules in the center portion and liquid crystal molecules positioned around the molecules in the center portion.

In this liquid crystal display device, the auxiliary electrodes 14 to generate electric fields of a predetermined value between these electrodes 14 and the opposing electrode 15 are provided on the inner surface of the TFT substrate 1, respectively corresponding to portions adjacent to at least the TFTs 4 around the plural pixel electrodes 3. Therefore, even when a great potential difference exists between the pixel electrodes and the gate electrodes through which a gate signal is supplied to the TFT 4 for every pixel, an electric field depending on the potential difference is shut off by the auxiliary electrode, which thus functions as a shield electrode. It is hence possible to reduce disturbance in orientation of liquid crystal molecules 20a in each pixel, which is caused by disturbance in the electric field in the portions surrounding the pixel due to a great potential difference between the gate signal and the pixel electrode. Accordingly, an image having an excellent quality without roughness can be displayed.

That is, in this liquid crystal display device, the auxiliary electrodes 14 are provided on the inner surface of the TFT substrate 1, respectively corresponding to portions adjacent to at least the TFTs 4 around the plural pixel electrodes 3. An electric filed of a predetermined value smaller than the voltage value of a gate signal supplied to the gate electrode 5 of the TFT 4 is generated between the auxiliary electrode 14 and the opposing electrode 15. Therefore, a strong lateral electric field generated along the substrate surface between the gate electrode supplied with the gate signal of the TFT and portions of the pixel electrode which is adjacent to the TFT is shut off and substantially shielded. Therefore, it is possible to prevent unnecessary behavior of liquid crystal molecules in those peripheral regions of the pixels that are adjacent to the TFTs, caused by influences from the lateral electric field. Thus, disturbance in orientation of liquid crystal molecules in each pixel can be prevented.

In the case of this embodiment, portions of the auxiliary electrodes 14 where the source electrodes 10 of the TFTs 4 extend are not opposed to the opposing electrode 15. In these portions where the source electrodes 10 extend, an electric field based on data signals and another electric field based on the gate signal to the TFTs 4 are generated. The regions where these electric fields are generated are so small that liquid crystal molecules 20a in those regions of the pixels that are adjacent to the TFTs 4 are less disturbed by influences from the lateral electric field.

In addition, in this embodiment, the portion of the source electrode 10 of the TFT 4 that extends above the auxiliary electrode 14 is formed to be narrower than the width of another portion of the source electrode 10 above the i-type semiconductor firm 7, i.e., the channel width of the TFT 4 as far as the resistance value of the former portion does not exceed an allowable value. Thus, the region of the auxiliary electrode 14 that is opposed to the opposing electrode 15 is elongated. As a result, the generation area of the lateral electric field generated by supply of a gate signal to the TFT 4 can be smaller. It is hence possible to reduce much more disturbance in orientation of the liquid crystal molecules 20a in those regions of pixels that are adjacent to the TFTs 4.

Further, in this embodiment such a portion of the peripheries of the pixel electrode 3 that is adjacent to the TFT 4 is cut away so that the pixel electrode 3 is formed in a shape in which the pixel electrode 3 is apart from the TFT 4. The source electrode 10 of the TFT 14 is formed so as to extend above the auxiliary electrode 14 in the region corresponding to the cut-away portion of the pixel electrode 3. Therefore, a lateral electric field is hard to be generated in the portion where the source electrode 10 extends. The strength of the lateral electric field can be weakened. Accordingly, disturbance in orientation of the liquid crystal molecules 20a in those regions of the pixels that are adjacent to the TFTs 4 can be almost eliminated.

Also in this embodiment, the auxiliary electrodes 14 are provided corresponding to peripheral portions adjacent to the TFTs 4 and the gate signal lines 11 around the pixel electrodes 3, respectively. Therefore, it is possible to eliminate disturbance in orientation of liquid crystal molecules 20a in those regions of the pixels that are adjacent to the gate signal lines 11.

Further in this embodiment, the auxiliary electrode 14 is provided around the whole periphery of the pixel electrode 3, so that an intersubstrate electric field (the electric field between the auxiliary electrode 14 and the opposing electrode 15) is equalized throughout the whole periphery of the pixel. Therefore, in correspondence with voltages applied between the pixel electrodes 3 and the opposing electrode 15, the orientation state of the liquid crystal molecules 20a in each pixel can be uniformed for every pixel. Accordingly, an image having more excellent quality can be displayed.

In addition, in this embodiment, the auxiliary electrodes 14 are set to a potential equal to the potential of the opposing electrode 15. A region where a substantially zero electric field is generated is formed between the auxiliary electrode 14 and the opposing electrode 15. Therefore, regions surrounding the pixel are set in a substantially electric-field-free state throughout the whole periphery of the pixel, i.e., a sate in which the liquid crystal molecules 20a are oriented to be substantially vertical to the surfaces of the substrates 1 and 2. Therefore, for every pixel, liquid crystal molecules 20a can be oriented to tilt from the peripheries of the pixel toward the center portion thereof, in correspondence with an applied voltage. An image having much more excellent quality can be displayed.

Also in this embodiment, the auxiliary electrodes 14 are arranged to function also as capacitor electrodes which form a compensating capacitor between these electrodes 14 and the pixel electrodes 3. Therefore, the structure is simplified and a sufficient aperture ratio can be obtained.

### Second Embodiment

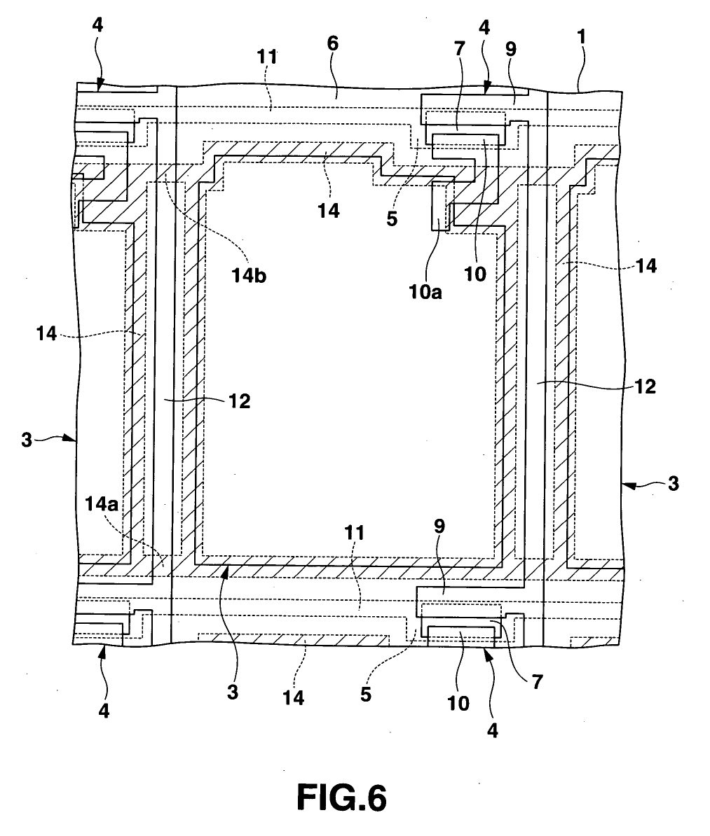

FIG. 6 shows the second embodiment of the present invention. FIG. 6 is a plan view showing of one pixel part in one substrate (TFT substrate) of the liquid crystal display device.

In the liquid crystal display device according to this second embodiment, auxiliary electrodes formed on the TFT substrate have a different shape from that of the auxiliary electrodes in the first embodiment. The other features of the structure are the same as those of the liquid crystal display device according to the first embodiment. Therefore, the same members as those in the first embodiment are denoted at the same reference symbols, and detailed descriptions thereof will be omitted herefrom.

That is, the auxiliary electrodes 14 each are made of a conductive film formed in a frame-like shape surrounding the whole periphery of a pixel electrode 3 on the substrate surface of the TFT substrate 1, like in the first embodiment. This frame-like conductive film is made of a metal film, transparent conductive film, or a composite film consisting of a metal film and a transparent conductive film. Edge portions of the auxiliary electrode 14 are formed to be such wide that the peripheral portions thereof on the inner peripheral side are opposed to peripheral portions of the pixel electrode 3 through the gate insulating film 6 (not shown) while other peripheral portions outside portions opposed to the pixel electrode 3 extend to the outside of the pixel electrode 3.

On the inner surface of the TFT substrate 1, plural auxiliary electrode connection portions 14a and 14b are formed between every adjacent auxiliary electrodes 14 on each row, such that auxiliary electrodes 14 adjacent to each other on each row are connected to each other at plural portions on adjacent edge portions of the adjacent auxiliary electrodes 14, e.g., on one end side and the other end side of the adjacent edge portions.

Though not shown in the figures, an auxiliary electrode connection line (not shown) for connecting, in common, the auxiliary electrodes 14 in each row is provided outside one end or each of both ends of the arrayed region of the plural pixel electrodes 3, on the inner surface of the TFT substrate 1. The auxiliary electrodes 14 in each row are connected, in common, to the auxiliary electrode connection line through plural lead portions having a width equal to or greater than the width of the auxiliary electrode connection portions 14a and 14b, extended from plural portions of outer edge portions of the auxiliary electrodes 14 on one end or two ends of each row, e.g., extended from two portions on one end side and the other end side of the edge portions.

In this liquid crystal display device, the plural auxiliary electrode connection portions 14a and 14b are formed between every adjacent ones of the plural auxiliary electrodes 14 on each row, the connection portions 14a and 14b connecting the adjacent auxiliary electrodes 14 to each other at two portions on one end side and the other end side of the adjacent edge portions of the auxiliary electrodes 14. Therefore, the auxiliary electrodes 14 can be connected with a sufficiently small resistance value, so that a sufficient aperture ratio can be ensured.

### Third Embodiment

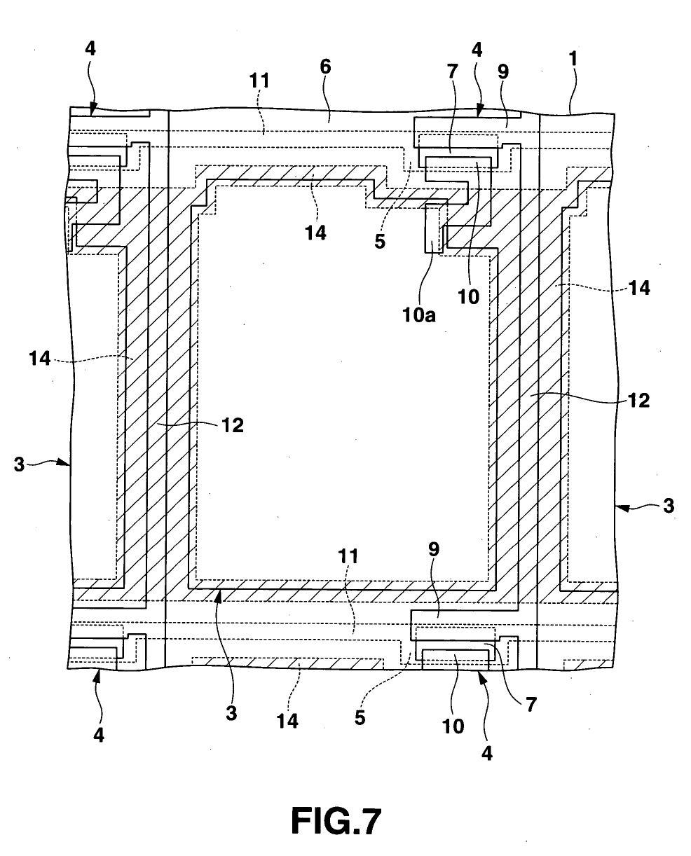

FIG. 7 shows the third embodiment of the present invention. FIG. 7 is a plan view showing one pixel part in one substrate (TFT substrate) of the liquid crystal display device.

In the liquid crystal display device according to this third embodiment, auxiliary electrodes formed on the TFT substrate have a different shape from that of the auxiliary electrodes in the first embodiment. The other features of the structure are the same as those of the liquid crystal display device according to the first embodiment. Therefore, the same members as those in the first embodiment are denoted at the same reference symbols, and detailed descriptions thereof will be omitted herefrom.

That is, the auxiliary electrodes 14 each are made of a conductive film formed in a frame-like shape surrounding the whole periphery of a pixel electrode 3 on the substrate surface of the TFT substrate 1, like in the first embodiment. Edge portions of the auxiliary electrode 14 are formed to be such wide that the peripheral portions thereof on the inner peripheral side are opposed to peripheral portions of the pixel electrode 3 through the gate insulating film 6 (not shown) while other peripheral portions on the outer peripheral side outside portions opposed to the pixel electrode 3 extend to the outside of the pixel electrode 3.

Further, the auxiliary electrodes 14 are formed corresponding to those peripheries (in the column direction) of the pixel electrodes 3 that are close to the TFTs 4 and the scanning signal lines, and also corresponding to those peripheries (in the row direction) of adjacent pixel electrodes in respective rows that are opposed to each other. Further, every adjacent auxiliary electrodes in each row of pixel electrodes are formed corresponding to those peripheries of the pixel electrodes that are opposed to each other. These adjacent auxiliary electrodes are formed integrally to be connected to each other. That is, those auxiliary electrodes that are formed corresponding to the peripheries of the pixel electrodes in the row directions are formed in a wide integral shape having a width corresponding to the distance between adjacent pixel electrodes, and a width overlapping each of the adjacent pixel electrodes.

In this liquid crystal display device, those portions of the auxiliary electrodes 14 on each row that are adjacent to each other are formed integrally. Therefore, the auxiliary electrodes 14 can be connected with a sufficiently small resistance value, and so, a sufficient aperture ratio can be ensured.

### Fourth Embodiment

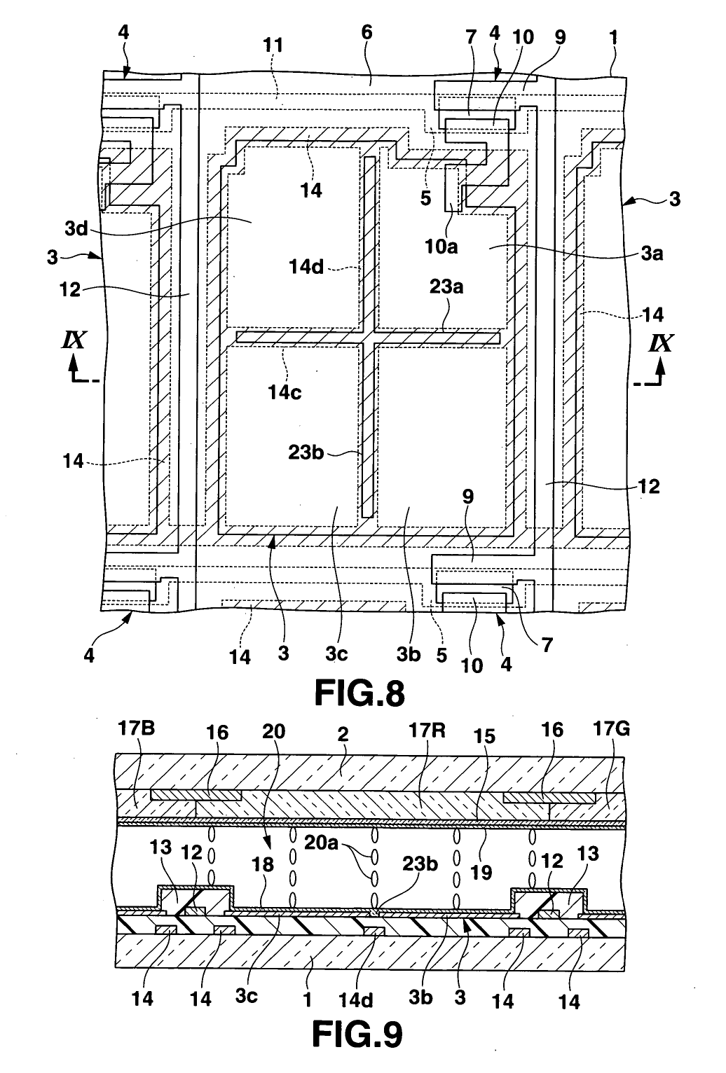

FIGS. 8 to 11 shows the fourth embodiment of the present invention. FIG. 8 is a plan view of one pixel part in one substrate (TFT substrate) of a liquid crystal display device. FIG. 9 is a cross-sectional view of the liquid crystal display device, cut along the lines IX-IX in FIG. 8.

In the liquid crystal display device according to this embodiment, those members corresponding to those of the first embodiment described above will be denoted at the same reference symbols. Detailed descriptions of identical members will be omitted herefrom.

In the liquid crystal display device according to this embodiment, a slit 23a extending in the row direction and another slit 23b extending in the column direction are provided in each of the plural pixel electrodes 3 provided on the inner surface of the TFT substrate 1, with the slits intersecting each other. Each of the pixel electrodes 3 is thereby divided into plural (four in this embodiment) electrode portions 3a, 3b, 3c, and 3d having areas substantially equal to each other. The other features of the structure are the same as those of the first embodiment.

The slits 23a and 23b each are formed to be such long that both ends of each slit are positioned slightly inside the peripheries of the pixel electrode 3. In peripheral portions on both end sides each of the slits 23a and 23b, the electrode portions 3a, 3b, 3c, and 3d are connected to each other.

Further, the auxiliary electrode 14 is provided with extension portions 14c and 14d formed respectively corresponding to the slits 23a and 23b of the pixel electrode 3, and generates an electric field of a predetermined value between the auxiliary electrode 14 and the opposing electrode 15 provided on the opposing substrate 2 (a zero electric field in which the opposing electrode 15 and the auxiliary electrode 14 are set to an equal potential).

Like in the first embodiment described previously, the auxiliary electrode 14 serves also as a capacitor electrode which forms compensating capacitor between the auxiliary electrode 14 and the pixel electrode 3, and is provided throughout the whole periphery of the pixel electrode 3. Therefore, a compensating capacitor having a sufficient capacitance value can be formed by those portions of the auxiliary electrode 14 that are opposed to peripheral portions of the pixel electrode 3.

Therefore, in this embodiment the extension portions 14c and 14d of the auxiliary electrode 14 are formed such that both side peripheries of the extension portions 14c and 14d are opposed to the both side peripheral portions of the slits 23a and 23b of the pixel electrode 3, with a slight overlapping width. Thus, light-shielded regions shielded by the extension portions 14c and 14d of the auxiliary electrodes 14 are reduced to be as small as possible, so that a sufficient aperture ratio can be ensured.

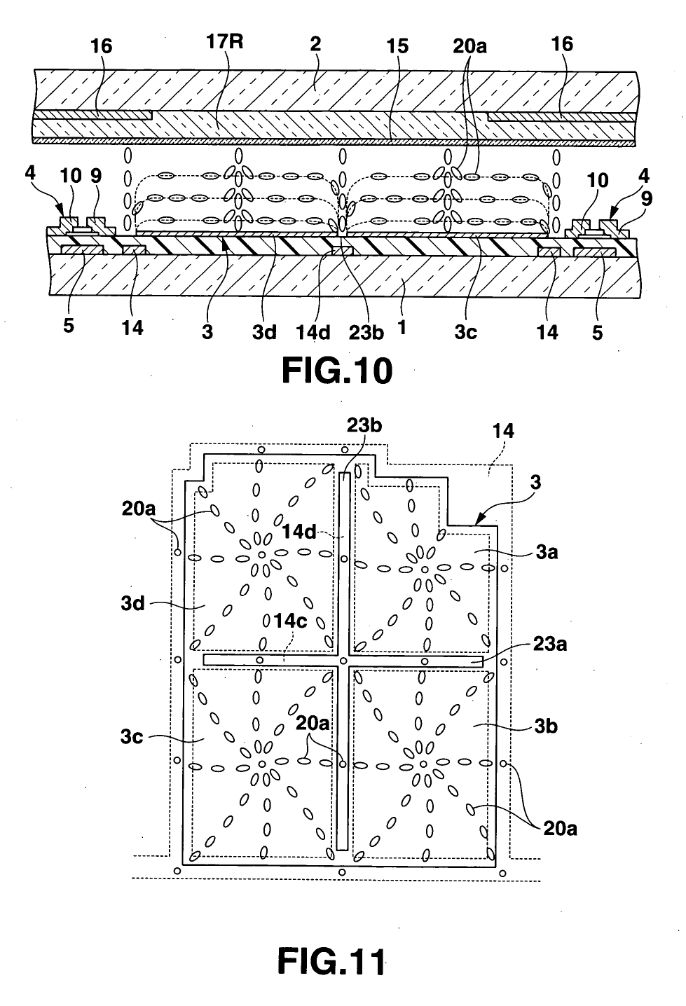

FIGS. 10 and 11 are schematic view showing a tilted-alignment state of liquid crystal molecules 20a in one pixel part of the liquid crystal display device according to this embodiment. For every region respectively corresponding the plural electrode portions 3a, 3b, 3c, and 3d divided by the slits 23a and 23b of the pixel electrode 3, the liquid crystal molecules 20a tilt aligned spirally toward the center portion from the peripheral portions of each of the regions, with the major axes of molecules oriented in directions along the equipotential lines indicated by broken lines in FIG. 10, as a voltage is applied between the pixel electrode 3 and the opposing electrode 15. The liquid crystal molecules in the center portion of each of the regions are oriented so as to stand vertically, by intermolecular force interactively acting between these liquid crystal molecules in the center portion and the liquid crystal molecules around the center portion.

In the liquid crystal display device according to this embodiment, each of the plural pixel electrodes 3 is provided with the slits 23a and 23b dividing the pixel electrode 3 into plural electrode portions. Therefore, when a voltage is applied between electrodes opposed to each other, an alignment state in which liquid crystal molecules 20a are aligned to tilt corresponding to the applied voltage is uniform and stabled between the plural regions. This is an advantage obtained in addition to the advantages of the liquid crystal display device according to the first embodiment, display unevenness can be eliminated and a high quality image can be displayed.

In the fourth embodiment, the extension portions 14c and 14d respectively corresponding to the slits 23a and 23b are formed in each of the auxiliary electrodes 14. However, these extension portions 14c and 14d can be omitted. Even in this case, the liquid crystal molecules 20a can be oriented to tilt corresponding to a write voltage, for every one of the plural regions. Display unevenness can thus be eliminated and a high-quality image can be displayed.

Also in the fourth embodiment, each of the pixel electrodes 3 is provided with one slit 23a along the row direction and one slit 23b along the column direction, such that these slits intersect with each other at the center portion of the pixel electrode 3. However, the number and directions of the slits which divide the pixel electrode 3 into plural electrode portions may be arbitrarily determined.

### Fifth Embodiment

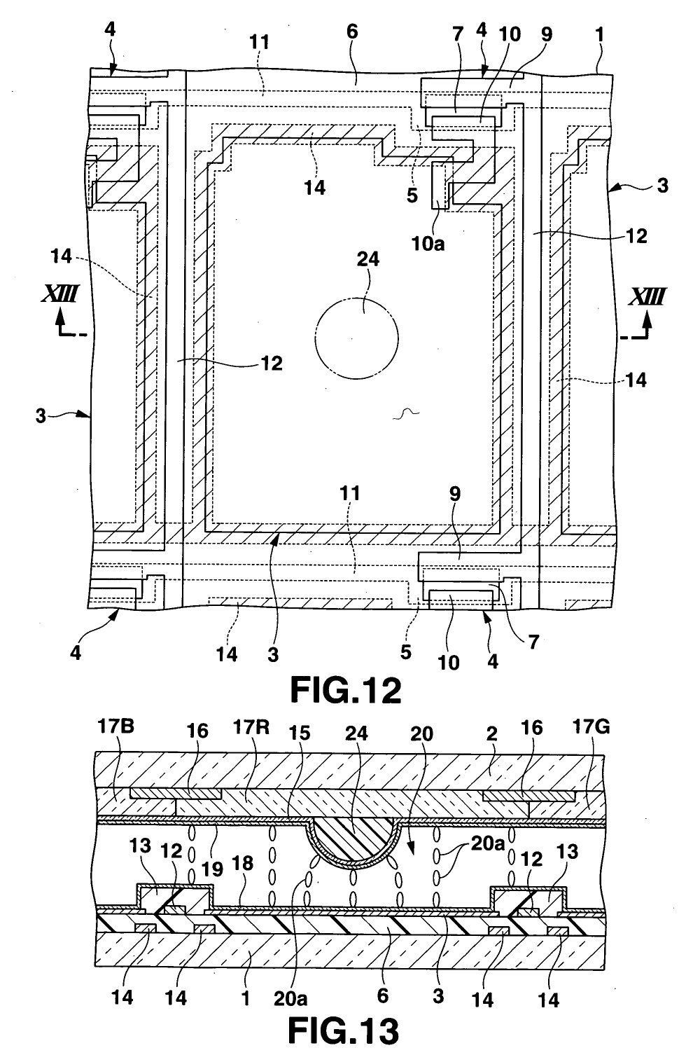

FIGS. 12 to 15 shows the fifth embodiment of the present invention. FIG. 12 is a plan view showing one pixel part of one substrate (TFT substrate) of a liquid crystal display device. FIG. 13 is a cross-sectional view of the liquid crystal display device along the line XIII-XIII in FIG. 10.

In this liquid crystal display device of the present embodiment, those components that correspond to the components of the liquid crystal display device according to the first embodiment will be denoted at identical reference symbols, and descriptions to those identical components will be omitted herefrom.

In the liquid crystal display device in the present embodiment, plural transparent projections 24 are provided respectively corresponding to the center portions of plural pixel electrodes 3 provided on a TFT substrate 1, on the inner surface of an opposing substrate 2. The other features of the structure are the same as those of the liquid crystal display device according to the first embodiment.

The plural projections 24 are formed of an insulating material such as photosensitive resins or the like, on color filters 17R, 17G, and 17B of three colors of red, green, and blue, which are formed on the inner surface of the opposing substrate 2. An opposing electrode 15 is formed in such a shape that a part of the opposing electrode above the projection 24 protrudes along the surface of the projection 24, covering the projection 24.

Further, a vertical-alignment film 19 on the inner surface of the opposing substrate 2 is formed covering a part above the projection 24. Liquid crystal molecules 20a in a part corresponding to the projection 24 are oriented as follows. That is, the liquid crystal molecules 20a in a part close to the projection 24 are oriented with their major axes of molecules oriented in directions substantially vertical to the surface (semispherical surface) of the projection 24. Other liquid crystal molecules 20a close to the TFT substrate 1 are oriented with their major axes of molecules oriented in a direction substantially vertical to the surfaces of the substrates 1 and 2.

In this embodiment, the projection 24 is formed in a semispherical shape. Among liquid crystal molecules 20a of the liquid crystal layer 20 near the opposing substrate 2, the liquid crystal molecules 20a around the projection 24 are oriented in an alignment state in which the major axes of molecules are oriented in directions along radiation rays from the center of curvature of the semispherical projection 24.

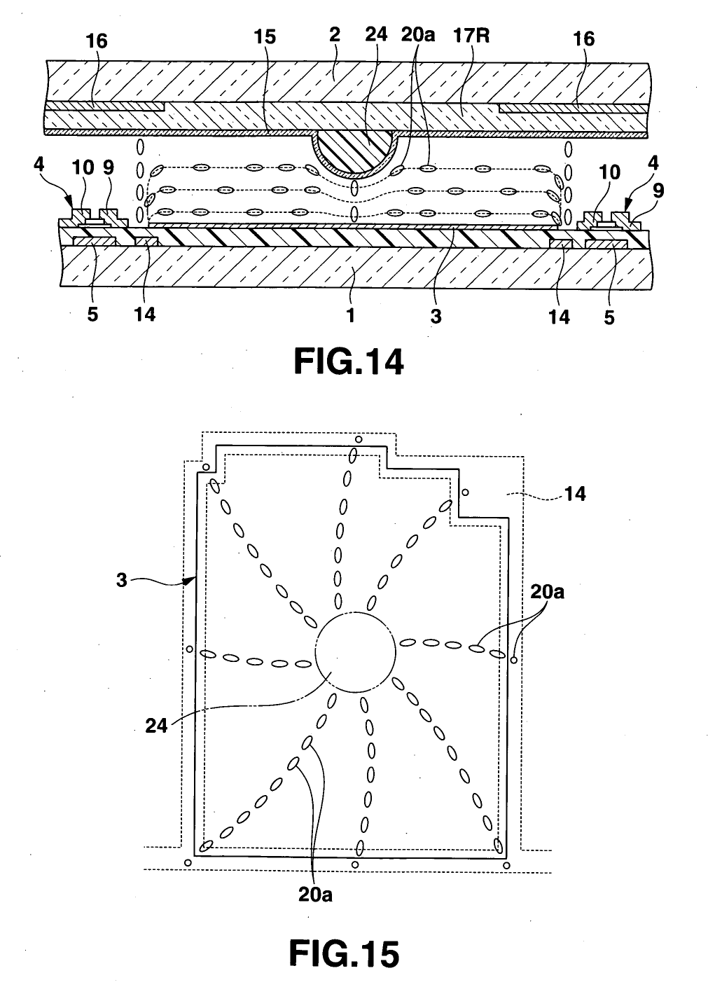

FIGS. 14 and 15 are cross-sectional and plan views showing a tilted-alignment state of liquid crystal molecules 20a in one pixel part of the liquid crystal display device according to the present embodiment. For every pixel, as a voltage is applied between the pixel electrode 3 and the opposing electrode 15, the liquid crystal molecules 20a tilt aligned spirally from the peripheral portions of the pixel toward the center portion thereof, with the major axes of molecules oriented in directions along equipotential lines indicated by broken lines in FIG. 14. At the center portion of the pixel, the liquid crystal molecules are oriented to be substantially vertical to the surface of the projection 24.

In the liquid crystal display device according to this embodiment, plural projections 24 respectively corresponding to the center portions of the plural pixel electrodes 3 are provided on the inner surface of the opposing substrate 2. The liquid crystal molecules 20a near the projection 24 are aligned, with the major axes of molecules oriented in directions substantially vertical to the surface of the projection 24. Therefore, the tilting direction of liquid crystal molecules 20a in each pixel, depending on application of a voltage, can be defined such that the liquid crystal molecules 20a tilt from the peripheral portions of the pixel toward the center portion thereof. Accordingly, the liquid crystal molecules 20a in each pixel can be regularly oriented to tilt, and so, display unevenness between each pixel is eliminated. As a result, a high-quality image can be displayed.

Also, in this embodiment, the opposing electrode 15 is formed covering the projections 24. Therefore, even when a voltage is applied between electrodes, electric charges are not stored in the projection 24 formed of an insulating material. Accordingly, burn-in on the display can be prevented.

Although the projection 24 is formed in a semispherical shape in this embodiment, the projection 24 is not limited to a semispherical shape but may be formed in a conical shape or a truncated conical shape whose diameter decreases toward the protruding end.

In the fourth and fifth embodiments described above, it is possible to use, in place of the auxiliary electrodes 14, such auxiliary electrodes 14 each having plural auxiliary electrode connection portions 14a and 14b, as shown in the second embodiment. The auxiliary electrode connection portions 14a and 14b are formed corresponding to mutually-opposing peripheries of adjacent electrodes in each row of pixel electrodes, and connect, at plural portions, the adjacent auxiliary electrodes to each other.

Further, in the fourth and fifth embodiments described above, it is possible to adopt, in place of the respective auxiliary electrodes 14, such auxiliary electrodes as shown in the third embodiment in which adjacent auxiliary electrodes formed at mutually-opposing peripheries of adjacent pixel electrodes on each row of pixel electrodes are connected to each other.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2004-347732 filed on Nov. 30, 2004 and Japanese Patent Application No. 2005-91143 filed on Mar. 28, 2005 and including specification, claims, drawings and summary. The disclosures of the above Japanese Patent Applications are incorporated herein by reference in their entireties.

What is claimed is:

1. A liquid crystal display device comprising:
a pair of substrates opposed to each other with a predetermined gap maintained therebetween;
plural pixel electrodes provided on an inner surface of one of the substrates among mutually-opposing inner surfaces of the substrates, and aligned in a matrix in row and column directions;
plural thin film transistors provided respectively corresponding to the plural pixel electrodes, on the one of the substrates, and respectively connected to corresponding pixel electrodes;
scanning signal lines and data signal lines provided respectively between pixel electrode rows and between pixel electrode columns, in which the plural pixel electrodes are arrayed in row and column directions, on the inner surface of the one of the substrates, thereby to connect plural thin film transistors to each other in each of the pixel electrode rows and in each of the pixel electrode columns, and to supply a scanning signal and a data signal to each of the thin film transistors;
an opposing electrode provided on an inner surface of the other one of the substrates and opposed to the plural pixel electrodes;
auxiliary electrodes provided on the inner surface of the one of the substrates, respectively corresponding to those portions of the plural pixel electrodes that are close at least to the thin film transistors, and respectively between the pixel electrodes and the thin film transistors, the auxiliary electrodes being applied with a predetermined potential;
vertical-alignment films respectively provided on the inner surfaces of the pair of substrates, covering the electrodes; and
a liquid crystal layer sealed in the gap between the pair of substrates and having negative dielectric anisotropy.

2. The liquid crystal display device according to claim 1, wherein each of the auxiliary electrodes is arranged, partially opposed to the opposing electrode, and an electric field of a predetermined value is applied between each of the auxiliary electrodes and the opposing electrode.

3. The liquid crystal display device according to claim 2, wherein the auxiliary electrodes are set to a potential equal to that of the opposing electrode, to form a region applied with no electric field between the auxiliary electrodes and the opposing electrode.

4. The liquid crystal display device according to claim 1, wherein the auxiliary electrodes are provided respectively corresponding to peripheral portions adjacent at least to the thin film transistors and the scanning signal lines, around the pixel electrodes.

5. The liquid crystal display device according to claim 1, wherein the auxiliary electrodes each are provided throughout the whole periphery of the pixel electrode.

6. The liquid crystal display device according to claim 1, wherein the auxiliary electrodes each are formed, partially overlapping the pixel electrode along peripheral portions of the pixel electrode, with an insulating film inserted therebetween.

7. The liquid crystal display device according to claim 6, wherein the auxiliary electrodes are formed to be integral with capacitor electrodes forming a compensating capacitor between the auxiliary electrodes and the pixel electrodes.

8. The liquid crystal display device according to claim 1, wherein the auxiliary electrodes further have auxiliary electrode connection portions formed at mutually-opposing peripheries of each adjacent ones of the pixel electrodes in each of the pixel electrode rows, and
each adjacent ones of the auxiliary electrodes in each of the pixel electrode rows are connected to each other at plural portions by the auxiliary electrode connection portions.

9. The liquid crystal display device according to claim 1, wherein the auxiliary electrodes further have auxiliary electrode connection portions formed at mutually-opposing peripheries of each adjacent ones of the pixel electrodes in each of the pixel electrode rows, and
each adjacent ones of the auxiliary electrodes in each of the pixel electrode rows are formed in an integral shape, to be connected to each other.

10. The liquid crystal display device according to claim 1, wherein the auxiliary electrodes are formed on a substrate surface of the one of the substrates, the pixel electrodes are formed on an insulating film provided covering the auxiliary electrodes, and connection electrodes connecting the pixel electrodes to electrodes on semiconductor films of the thin film transistors are formed such that portions thereof extending above the auxiliary electrodes are shaped to be narrower than a width of the electrodes on the semiconductor films of the thin film transistors.

11. The liquid crystal display device according to claim 1, wherein the pixel electrodes each are formed in a shape in which such a part of a periphery of the pixel electrode that is adjacent to the thin film transistor is apart from the thin film transistor, a connection electrode connecting an electrode of the thin film transistor on a semiconductor film to the pixel electrode is formed to intersect the auxiliary electrode, within a region corresponding to the part apart from the thin film transistor.

12. A liquid crystal display device comprising:
a pair of substrates opposed to each other with a predetermined gap maintained therebetween;
plural pixel electrodes provided on an inner surface of one of the substrates among mutually-opposing inner surfaces of the substrates, and aligned in a matrix in row and column directions;
plural thin film transistors provided respectively corresponding to the plural pixel electrodes, on the inner surface of the one of the substrates, and respectively connected to corresponding pixel electrodes;
scanning signal lines and data signal lines provided respectively between pixel electrode rows and between pixel electrode columns, in which the plural pixel electrodes are arrayed in row and column directions, on the inner surface of the one of the substrates, thereby to connect plural thin film transistors to each other in each of the pixel electrode rows and in each of the pixel electrode columns, and to supply a scanning signal to a gate electrode of each of the thin film transistors as well as a data signal to a drain electrode of each of the thin film transistors;
an opposing electrode provided on an inner surface of the other one of the substrates and opposed to the plural pixel electrodes;
auxiliary electrodes provided on the inner surface of the one of the substrates, at least between the plural pixel electrodes and the thin film transistors respectively corresponding to pixels, thereby to shield an electric field applied between the gate electrodes and the pixel electrodes;
vertical-alignment films provided respectively on the inner surfaces of the pair of substrates, covering the electrodes; and
a liquid crystal layer sealed in the gap between the pair of substrates and having negative dielectric anisotropy.

13. The liquid crystal display device according to claim 12, wherein the auxiliary electrodes each are provided at least between the pixel electrode, the gate electrode of the thin film transistor, and a scanning line which supplies the gate electrode with a scanning signal.

14. The liquid crystal display device according to claim 12, wherein the auxiliary electrodes each are formed along peripheral portions of the pixel electrode, with a part of the auxiliary electrode overlapping the pixel electrode through an insulating film, and with another part thereof opposed to the opposing electrode.

15. The liquid crystal display device according to claim 12, wherein the auxiliary electrodes each are provided throughout the whole periphery of the pixel electrode.

16. The liquid crystal display device according to claim 15, wherein the auxiliary electrodes are formed to be integral with capacitor electrodes forming a compensating capacitor between the auxiliary electrodes and the pixel electrodes.

17. The liquid crystal display device according to claim 12, wherein the auxiliary electrodes each are formed to be opposed to the opposing electrode along peripheral portions of the pixel electrode, and are set to a potential substantially equal to a potential of the opposing electrode, thereby to form a region applied with no electric field between the auxiliary electrode and the opposing electrode.

18. The liquid crystal display device according to claim 1, wherein each of the plural pixel electrodes is provided with a slit which divides the plural pixel electrode into plural electrode portions, and an extension portion corresponding to the slit is formed on each of the auxiliary electrodes.

19. A liquid crystal display device comprising:
a pair of substrates opposed to each other with a predetermined gap maintained therebetween;
plural pixel electrodes provided on one of the substrates, among mutually-opposing inner surfaces of the pair of substrates, and arrayed in a matrix in row and column directions;
plural thin film transistors formed on the inner surface of the one of the substrates, respectively corresponding to the plural pixel electrodes and connected to corresponding ones of the pixel electrodes;
scanning signal lines and data signal lines provided respectively between pixel electrode rows and between pixel electrode columns, in which the plural pixel electrodes are arrayed in row and column directions, on the inner surface of the one of the substrates, thereby to connect plural thin film transistors to each other in each of the pixel electrode rows and in each of the pixel electrode columns, and to supply a scanning signal and a data signal to each of the thin film transistors;
an opposing electrode provided on an inner surface of the other one of the substrates and opposed to the plural pixel electrodes;
plural auxiliary electrodes provided on the inner surface of the one of the substrates, respectively surrounding the whole peripheries of the plural pixel electrodes, opposed to peripheral portions of the pixel electrodes at inner peripheral portions of the auxiliary electrodes, thereby to form a compensating capacitor between the auxiliary electrodes and the pixel electrodes, and also opposed to the opposing electrode at those portions of the auxiliary electrodes that extend to around the pixel electrodes, respectively, thereby to generate electric fields of a predetermined value between the auxiliary electrodes and the opposing electrode;
plural auxiliary electrode connection portions formed respectively between the plural auxiliary electrodes, thereby to connect every adjacent ones of the auxiliary electrodes on each of the rows, to each other, at plural portions of adjacent edge portions of the every adjacent ones of the auxiliary electrodes;
vertical-alignment films provided respectively on the inner surfaces of the pair of substrates, covering the electrodes; and
a liquid crystal layer sealed in the gap between the pair of substrates and having negative dielectric anisotropy.

20. The liquid crystal display device according to claim 19, wherein the auxiliary electrodes are formed on a substrate surface of the one of the substrates, the pixel electrodes are formed on an insulating film provided covering the auxiliary electrodes, and connection electrodes connecting the pixel electrodes to electrodes on semiconductor films of the thin film transistors are formed such that portions thereof extending above the auxiliary electrodes are shaped to be narrower than a width of the electrodes on the semiconductor films of the thin film transistors.
